(19) United States
(12) Patent Application Publication
(10) Pub. No.: US 2011/0107603 A1
(43) Pub. Date: May 12, 2011

(54) Folding knife with bidirectional latching mechanism

(75) Inventors: David Matthew Giuntoli, San Diego, CA (US); Walter Kaihatu, San Diego, CA (US)

(73) Assignees: David M. Giuntoli; Walter Kaihatu; 888 Professional, San Diego, CA (US)

(21) Appl. No.: 12/657,017

(22) Filed: Jan. 12, 2010

Related U.S. Application Data
(60) Provisional application No. 61/204,980, filed on Jan. 12, 2009.

(51) Int. Cl. B26B 1/04

(52) U.S. Cl. 30/161

(57) ABSTRACT

A folding knife/tool with a unique bi-directional latching mechanism that latches two handle-halves in the open and closed position. The said handle halves rotate about the same pivot as the blade/tool end. One handle half can be pivoted , unlatched, from the other, therefore allowing the handle halves to pivot exposing and securing the blade in the open, or closed position. The latching mechanism allows for Top Handle-Half to rotate clockwise or counter-clockwise relative to the Bottom Handle-Half and connect securely into the same latching mechanism.

### BACKGROUND OF THE INVENTION

The main premise behind this invention is to create a knife or tool with a minimum number of reliable parts to for a thin but safe pocket knife/tool.

For many years, a folding knives, or tool, have been a convenient and safe means to carry a knife. But the overall size of the product can be large for its usefulness. Or, in order to thin down the knife the safety of the knife is compromised. This invention describes a knife with a blade that is completely covered when closed. And to accomplish this, a clever latching mechanism is incorporated to hold open and closed the knife.

This invention allows a blade/tool end to be completely covered and also allow it to be opened and closed with one hand. The art of this invention allows for the knife/tool to have a narrow profile or thickness. The novelty of the latching mechanism of the said invention allows the handle halves to latch from both directions using the same latching components.

### REFERENCE PATENTS/PREVIOUS ART

U.S. Pat. No. 4,133,106

### SUMMARY OF INVENTION

The present invention relates to a folding knife, or hand tool, specifically a single bladed, folding pocketknife in which the blade is held closed and open by rotating one of handle halves about a main pivot. The handle halves, one on each side of the blade, rotate independently about the main (blade) pivot. The blade and both handle halves rotate 360 degrees around the central pivot. There is a single pivot in which the blade and both handle halves rotate about.

### BRIEF DESCRIPTION OF DRAWINGS

FIG. 1. Exploded View

FIG. 2. Orientation of stops.

FIG. 3. Stops details

FIG. 4. Blade in Transition.

FIG. 5. Blade Shoulder orientation

FIG. 6. Knife in Transition to Open

FIG. 7. Bidirectional Latching mechanism

FIG. 8, Opt 1. Optional Latching Mechanism, Ball Detent

FIG. 8, Opt 2. Optional Latching Mechanism, Moveable Detent

### DETAIL DESCRIPTION OF PREFERRED EMBODIMENT

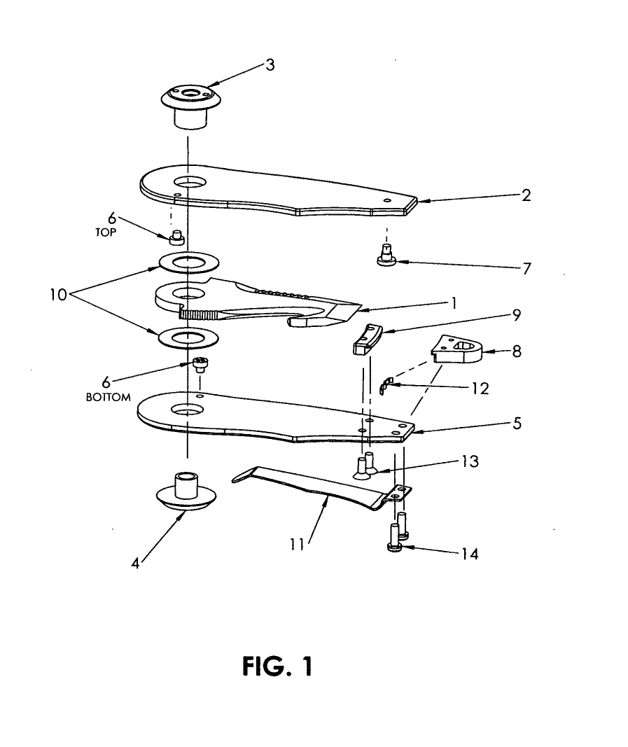

FIG. 1 shows an exploded view of the preferred embodiment. There are the top handle half (2), bottom handle half (5), and blade/tool end (1) all rotating about the central pivot (3). The handle halves (2) and (5) and blade (1) are held onto the central pivot by a pivot nut (4) that fastens onto the central pivot (3).

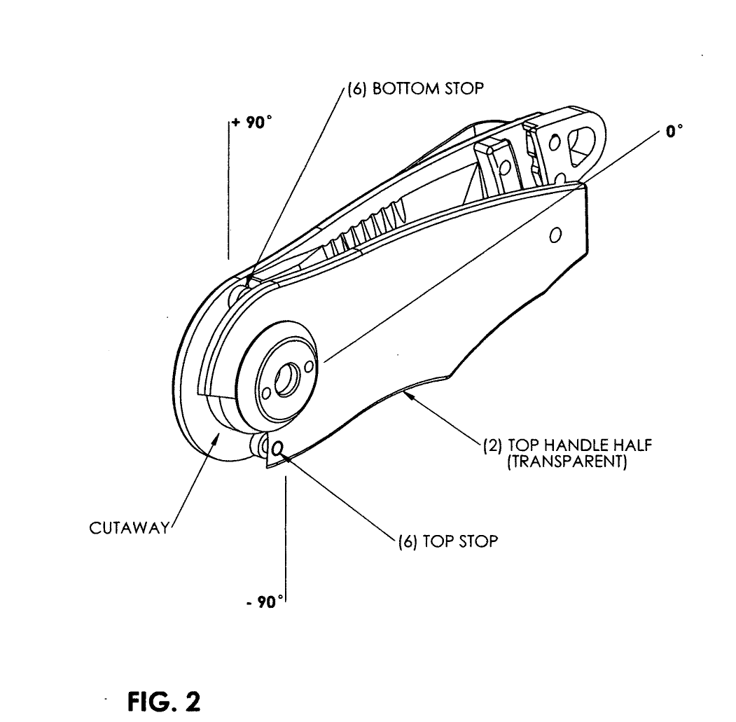

The top stop (6Top) is permanently attached to the top handle half (2) and positioned directly below the central pivot, 90 degrees clockwise from the center line of the said top handle half, See FIG. 2. The bottom stop (6 Bottom) is permanently attached to the said bottom handle half, again see FIG. 2.

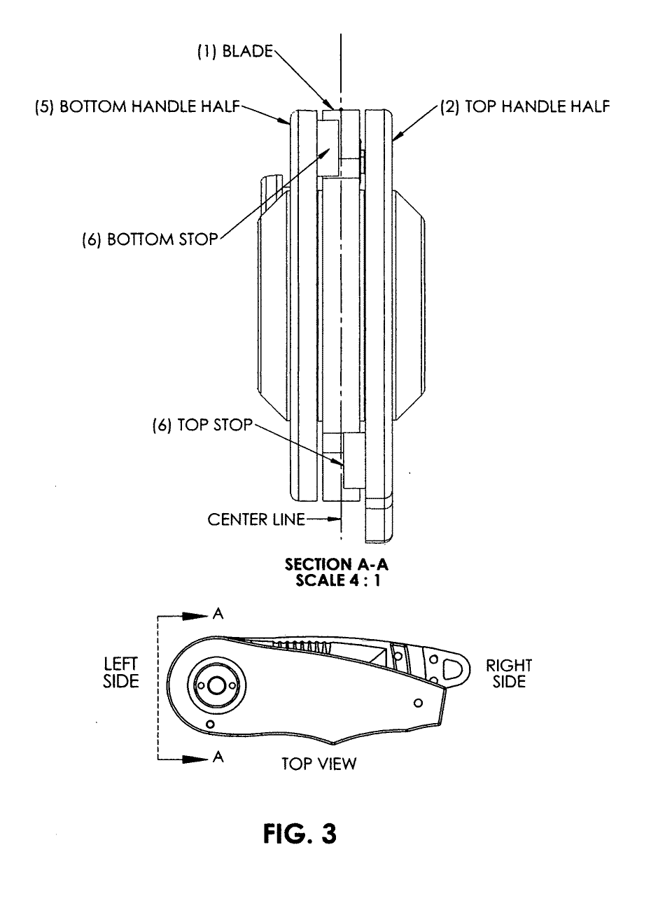

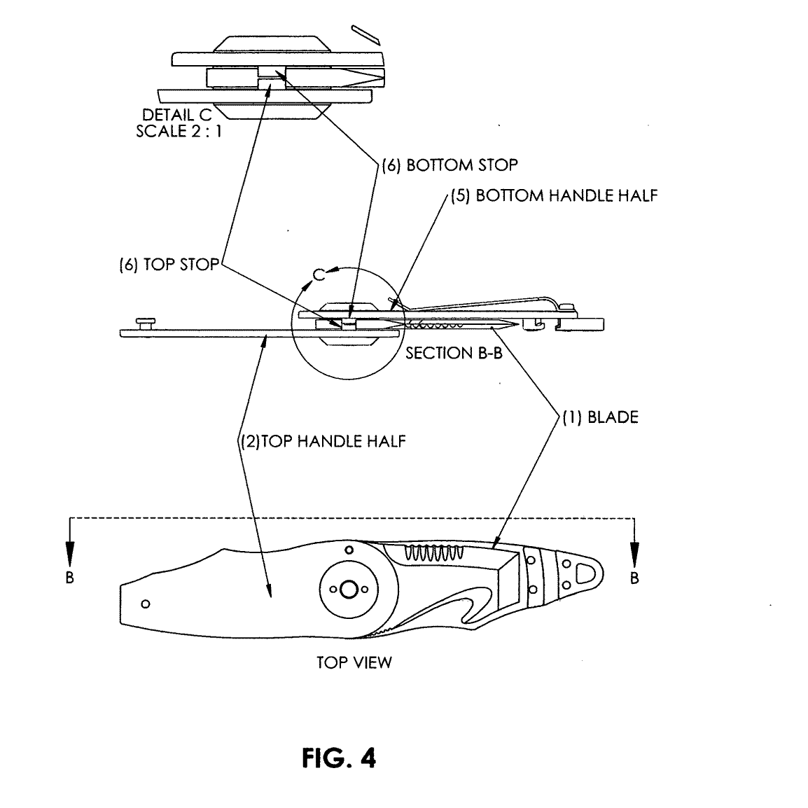

The heights of the two said stops are less than half the blade thickness. See FIG. 3. This allows the said two stops to pass over each other as the said top handle half is rotated 360 degrees around the said central pivot. In FIG. 4, said top handle half is positioned at 180 degrees.

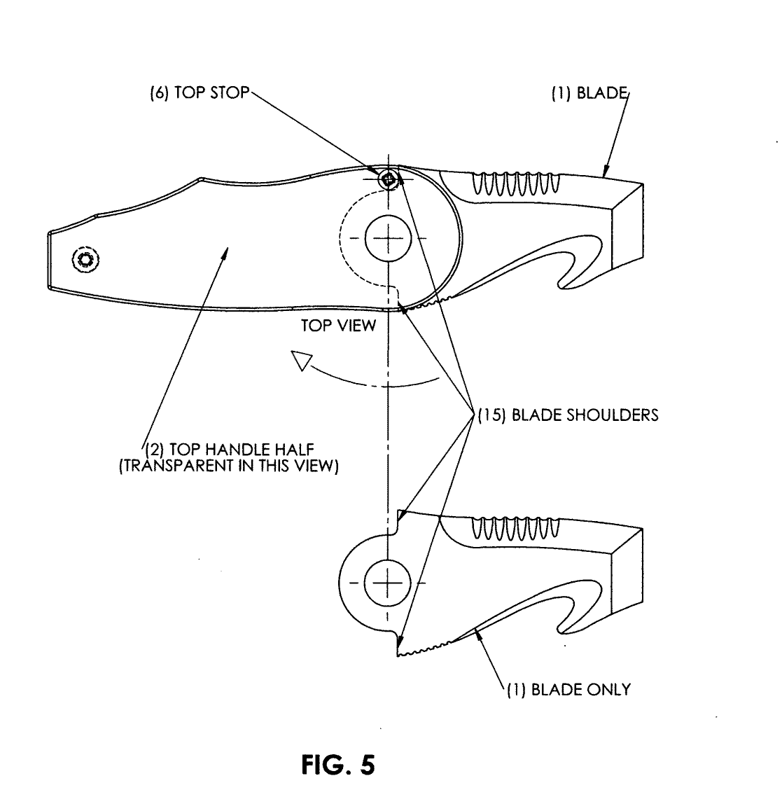

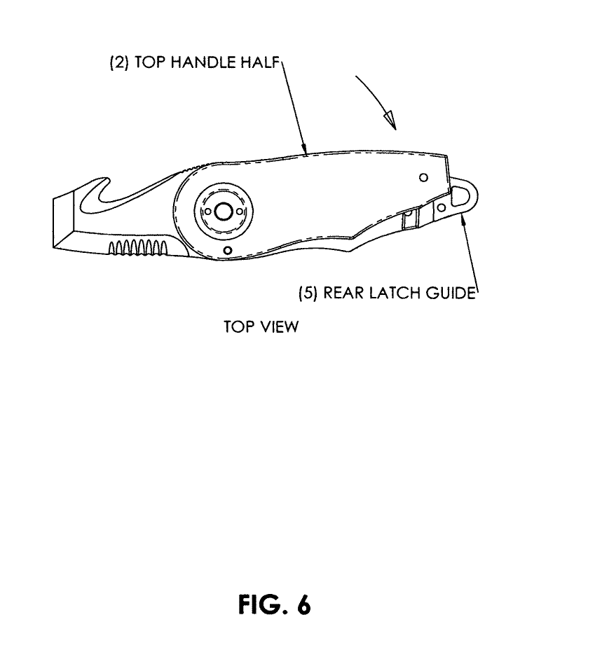

As the said top handle half passes through 180 degrees the said top stop contacts the blade shoulder (15). See FIG. 5. Further rotation of the said top handle half causes the blade to rotate about the said central pivot. Meanwhile the said bottom stop is stationary. FIG. 6 shows the said top handle half about to complete its rotation of 360 degrees.

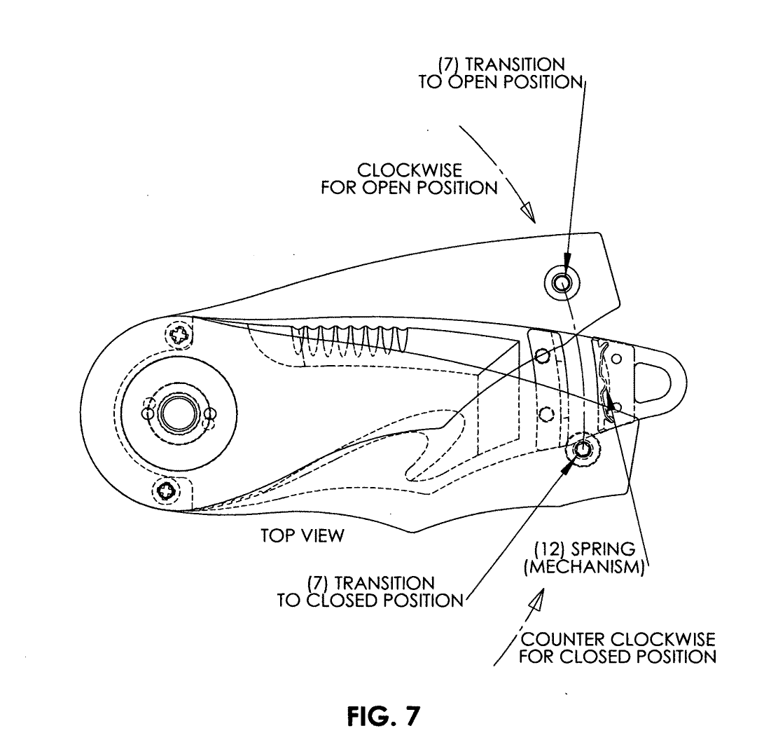

Once the said top handle half has rotated 360 degrees the latching screw (7) is captured the latching spring (12). The latching spring (12) has waving in form so that the said latching screw is captured from both side or from both directions, as the said top handle half rotates clockwise or counter-clockwise. See FIG. 7.

When the Blade (3,2,1) is in the OPEN position (FIG. 6), the two screw stops (16T, 16B) hold the blade by the said blade shoulders.

Reversing the just mentioned process the said top stop will contact the opposite blade shoulder and rotate the blade into the CLOSED position. Once in the closed position the blade with rest safely between the handle halves (15 & 9).

In the CLOSED position the said stops will again be opposite each other and hold in the blade beneath the said handle halves.

The said handle halves are spaced from the blade by two washers (10). These said washers provide a controlled friction surfaces for the said handle halves and blade to pivot about each other. The said washers also prevent the blade from contacting the said handle halves therefore preventing marring of blade and handle halves.

As shown in FIG. 1, a clip (11) can be attached so that the in the CLOSED position the knife can be secured to a pocket or “Molly type” webbing.

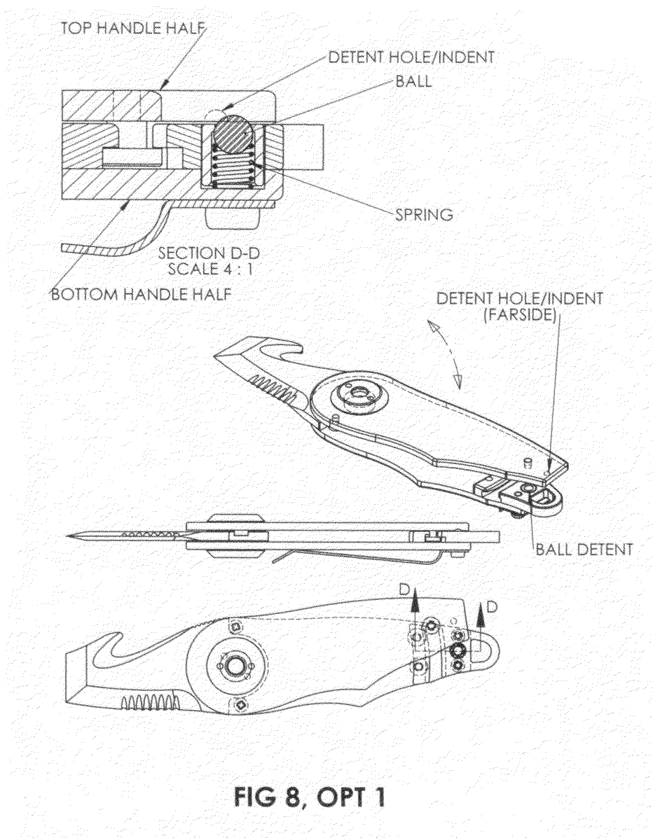

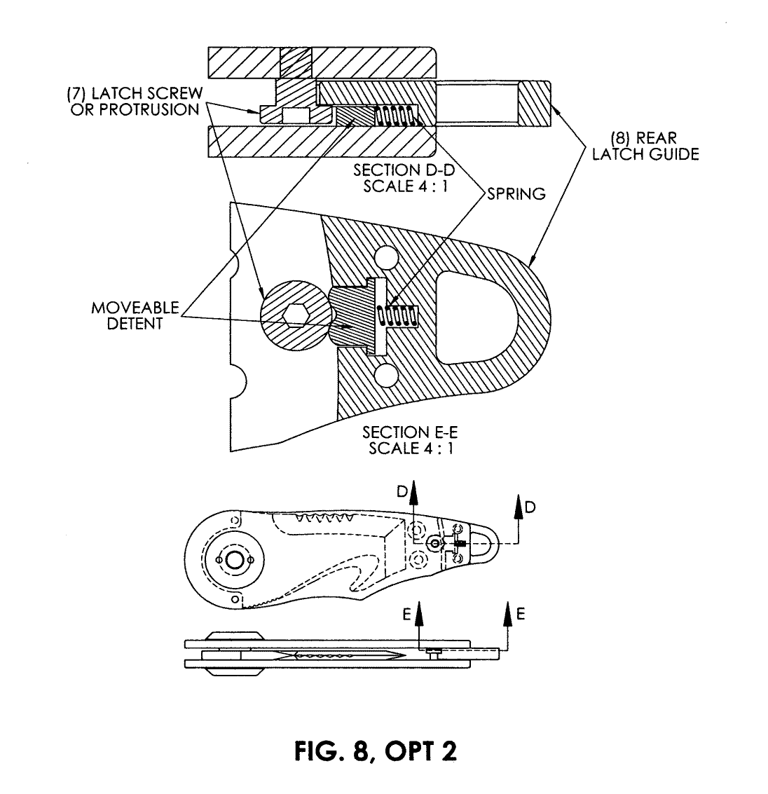

FIG. 8, Opt 1. shows a possible latching mechanism which is a spring loaded ball detent.

FIG. 8, Opt 2. shows another possible latching mechanisms which is a spring loaded detent.

Having described our invention, we claim:

1. Two handle halves and blade pivot about the same central pivot.

2. There is two stop features, one on each handle half, that holds the blade into the Open and Closed position.
a. These same stop features also causes the blade to rotate about the central pivot.
b. These same stop features are at such a height so that they can pass over each other without directly contacting each other.
c. These same stop features contact the both blade shoulders to move and hold the blade into several positions.
d. These same stop features can contact the same blade shoulder features at the same time.
e. One stop is permanently attached to each rotating handle half.
f. The two stop features are located 180 degree apart from each other, relative to the central pivot.

3. While the blade is in the OPEN OR CLOSED position the stop features are in contact with opposite blade shoulders. That is one spot is in contact with one blade shoulder.

4. The latching mechanism in singular in design and can be engaged from both the clockwise (OPEN) and counter-clockwise (CLOSED) positions.
a. The latching spring is such that its geometry allows for a round latching feature or protrusion to engage it. The round latching feature or protrude is therefore captured by the spring geometry.
b. This spring geometry is symmetrical therefore allowing for the latching feature to engage it equally from two directions.
